(19) United States
(12) Patent Application Publication
(10) Pub. No.: US 2022/0134384 A1
(43) Pub. Date: May 5, 2022

(54) SYSTEM AND METHOD FOR SEPARATING AND SINGULATING POSTAL ARTICLES

(71) Applicant: Beumer Corporation, Somerset, NJ (US)

(72) Inventors: Ertan Erden, Levittown, PA (US); Deep Gajjar, East Windsor, NJ (US); Alexander Raff, Washington, NJ (US); Subu Shankara Prasad, Monmouth Junction, NJ (US); Timothy Sussman, Madison, NJ (US); Raddath Juhuri, Bound Brook, NJ (US); Setu Parikh, East Windsor, NJ (US)

(73) Assignee: Beumer Corporation, Somerset, NJ (US)

(21) Appl. No.: 17/516,951

(22) Filed: Nov. 2, 2021

Related U.S. Application Data
(60) Provisional application No. 63/109,984, filed on Nov. 5, 2020.

(51) Int. Cl. B07C 1/04; B07C 3/08; B07C 3/14; B25J 9/16

(52) U.S. Cl. CPC B07C 1/04; B25J 9/1697; B07C 3/14; B07C 3/08

(57) ABSTRACT

The present disclosure concerns a method and a system for separating and singulating articles, such as postal parcels or small packages, said system comprising a feeding conveyor having a receiving end and a delivery end, and a divider for separating the bulk of postal articles arriving on the feeding conveyor into a plurality of parallel article streams on the feeding conveyor and forwarding said article streams in a first conveying direction from said receiving end to said delivery end; a takeaway conveyor having a second conveying direction, which is substantially different from said first conveying direction, and where said takeaway conveyor at its upstream end is abutted by the delivery end of said feeding conveyor; a plurality of gantry robots are provided across the delivery end of the feeding conveyor in such a way that each robot is handling each their article stream on the feeding conveyor and that the robots are adapted to picking an article from each their article stream on the feeding conveyor and placing said picked article on the takeaway conveyor; a vision system adapted to capturing image data of the articles on the feeding conveyor, and a robotic controller comprising a data processing unit for using said image data to identify an article to be singulated by one of the robots and for providing control inputs to the robots.

### CROSS-REFERENCE TO RELATED APPLICATIONS

This application claims priority to U.S. Provisional Patent Application No. 63/109,984, filed Nov. 5, 2020; which is incorporated herein by reference.

### FIELD OF THE INVENTION

The present disclosure relates to a system and a method for separating and singulating articles, such as postal parcels or small packages using robots for the singulating process.

### BACKGROUND OF THE INVENTION

U.S. Pat. No. 10,058,896 B2 discloses an installation for separating and singulating non-uniform postal articles. A vision system is overhead the stack of articles on a first conveyor. A single robot is controlled based on the data from the vision system and picks the articles individually and transfer the articles onto a second conveyor perpendicular to the first conveyor. Using a single robot facilitates the controlling of the pick and place process, but it also limits the capacity.

DE 10 2007 038 834 A1 discloses a system for singulating postal parcels with two robots, one robot on each side of the main conveyor and two side conveyors on each side of the main conveyor. The parcels are entered on the main conveyor in an irregular bulk and the parcels are singled out by the robots on each their side conveyors and returned to the main conveyor one by one. The conveying direction is not changed during the singulating process, which together with the two side conveyors results in a layout that takes up a lot of space. Moreover, as the robots overlap in range, the control of the two robots needs to be coordinated.

U.S. Pat. No. 9,676,003 B2 discloses a sorting machine with two robots taking parcels from a circular conveyor. Each robot feeds their separate flat conveyor. From the flat conveyors the sorted parcels are delivered on a conveyor perpendicular on the flat conveyors. The use of two robots expands the capacity and thereby the speed at which the articles can be picked up and singulated. However, the robots must be coordinated in their control, e.g. being of the collaborative robot type, since the robots overlap in operative range.

### OBJECT OF THE INVENTION

It is an object of the present invention to provide a compact and reliable system and method for separating and singulating postal articles with high capacity using robotic singulation.

### SUMMARY OF THE INVENTION

In a first aspect of the invention, this object is achieved by a system for separating and singulating articles, such as postal parcels or small packages, said system comprising a feeding conveyor having a receiving end and a delivery end, and a divider for separating the bulk of postal articles arriving on the feeding conveyor into a plurality of parallel article streams on the feeding conveyor and forwarding said article streams in a first conveying direction from said receiving end to said delivery end; a takeaway conveyor having a second conveying direction, which is substantially different from said first conveying direction, and where said takeaway conveyor at its upstream end is abutted by the delivery end of said feeding conveyor; a plurality of robots are provided in parallel across the delivery end of the feeding conveyor in such a way that each robot is handling each their article stream on the feeding conveyor and that the robots are adapted to picking an article from each their article stream on the feeding conveyor and placing said picked article on the takeaway conveyor; a vision system adapted to capturing image data of the articles on the feeding conveyor, and a robotic controller comprising a data processing unit for using said image data to identify an article to be singulated by one of the robots and for providing control inputs to the robots.

By the invention, it is realised that using a plurality of robots and organising them to work in parallel a compact layout of the singulator system can be achieved. The advantage of organising robots in a parallel formation across the feeding conveyor is that the robots hereby do not need to overlap in order to cover the entire pick-up area of the feeding conveyor. This allows for a very compact layout of the conveyors. A further advantage by the invention is that the singulating capacity is increased by using a plurality of robots, in particular in combination with the initial division of the bulk of articles into parallel streams of articles, so that there is formed one stream on the feeding conveyor for each robot to handle at the delivery end.

Preferably, the divider comprises a cascading diverter chute is provided upstream the feeding conveyor and preferably also with a divider element for the formation of two parallel article streams, preferably a centrally positioned divider element. Hereby, a simple and efficient division of the bulk of articles can be achieved into small groups of articles in a stream so that a robot can handle the articles and singulate them. It is not important that the streams of articles are equal in number of articles as the robots are controlled individually and are adapted to work at different speed.

Preferably, the second conveying direction is substantially perpendicular to said first conveying direction. This allows for a particularly compact layout of the system.

In the preferred embodiment of the invention, the robots are placing the picked article on the takeaway conveyor in a placement area at the upstream end of said takeaway conveyor. The articles irrespective of which stream of articles and consequently which robots is handling each of the articles, the articles are picked and sequentially placed on the takeaway conveyor for further processing.

In some embodiments of the invention, the conveying velocity of the feeding conveyor and/or the takeaway conveyor is variable. Furthermore, in an embodiment, the feeding conveyor may be intermittently driven (start-stop). By controlling the speed of the conveyor(s), the capacity of the robots may be further increased.

Preferably, the robots are gantry robots, or more preferably, the gantry robots may be 3-axis Cartesian robots and/or 6-axis Cartesian robots. This allows for a particularly compact layout with robots having each their work area complementing each other in an either overlapping or non-overlapping manner. The robots may further be collaborative robots, which is of preference if an overlap between the workspaces of the robots is present.

In other embodiments, the robots may be any one of SCARA robot, a delta robot or 6-axis robot type. Depending on the actual type of articles to be singulated particular types of robots may be of preference.

The robots are preferably each provided with a gripper for picking an article from each their article stream. In an advantageous embodiment, these the robot grippers are adapted to pneumatically picking an article from each their article stream. This provides for a simple and reliable method of picking, holding and placing an article.

In other embodiments, the robot grippers may comprise pneumatic suction cups, mechanical gripping fingers, or hybrid design grippers that utilize a suction cup primarily assisted with a mechanical finger gripper. The grippers could also be a soft robot gripper that could have a controlled movement by adjusting pressure through combinations of pneumatic networks. Thus, by the invention the type of grippers may be chosen in accordance with circumstances, such as the types of articles, their size, weight etc. that are to be handled by the robots.

Advantageously, the vision system is adapted to record image data of the articles on all of the article streams on the feeding conveyor. By providing a common vision system for all of the robots and associated streams of articles, the singulation process can be improved.

In a preferred embodiment, the takeaway conveyor is after the delivery end of feeding conveyor provided with an operator station and an auto reject station. Hereby, articles with an odd geometry so that the robots cannot pick handle them, can be manually sorted or automatically rejected. This is particularly useful with a layout with the feeding conveyor abutting the upstream end of the takeaway conveyor, and with a layout where both conveyors are in the same level or the feeding conveyor slightly higher in level. This layout allows for a cluster of complicated articles and/or odd-shaped articles can be delivered directly on the takeaway conveyor even if the robots cannot handle them. Such “unhandled” articles can then be dealt with either manually and/or automatically rejected from the takeaway conveyor. By this embodiment a more versatile singulation system is provided without comprising the singulation rate and thereby the capacity.

In a particular embodiment, the auto reject station comprises an air guided reject actuator on one side of the takeaway conveyor and a collection bin on the opposite side thereof. Hereby, if an odd-shaped article or the like is detected air nozzles can be activated so pressurised air is ejected causing the article to be blow sideways off the takeaway conveyor and into a collection bin.

In an advantageous embodiment of the invention, there is provided a tool exchange magazine for each of the gantry robots on the side of the delivery end of the feeding conveyor. As the gantry robots are preferably using pneumatic pick-up heads, such pick-up head tools can be damaged, worn or otherwise loose performance. By this embodiment, the robots can automatically detect such loss of performance, e.g. by detecting the pressure change in the pick-up head during use. If such pressure does not drop sufficiently when vacuum is applied, the robotic controller can direct the robot to the tool exchange magazine and reject the old pick-up tool head and attach a new tool head on the robot.

The gantry robots may be provided with overlap and the robotic controller may accordingly be adapted for ensuring a sequential placing of articles by the robots. This provides an even more compact layout of the system.

In a second aspect of the invention, there is provided a method of separating and singulating articles, such as postal parcels or small packages, comprising the steps of providing a bulk of postal articles, and dividing said bulk of articles into a plurality of parallel article streams on a feeding conveyor and forwarding said article streams in a first conveying direction from a receiving end to a delivery end of said feeding conveyor; providing a takeaway conveyor having a second conveying direction, which is substantially different from said first conveying direction, and where said takeaway conveyor at its upstream end is abutted by the delivery end of said feeding conveyor; providing a plurality of gantry robots are provided across the delivery end of the feeding conveyor in such a way that each robot is handling each their article stream on the feeding conveyor and that the robots are adapted to picking an article from each their article stream on the feeding conveyor and placing said picked article on the takeaway conveyor; capturing image data of the articles in the article streams on the feeding conveyor by a vision system adapted to, and processing said image data in a robotic controller to identify an article to be singulated and moved onto the takeaway conveyor by one of the gantry robots and for providing control inputs to the robots.

For the reasons explained above in relation to the first aspect, it is also found advantageous to provide a method of singulation using a plurality of gantry robots and organising them to work in parallel a compact layout of the singulator system can be achieved. The advantage of using gantry robots is that the robots do not need to overlap in order to cover the entire pick-up area of the feeding conveyor. This allows for a very compact layout of the conveyors. A further advantage by the invention is that the singulation capacity is increased by using a plurality of gantry robots, in particular in combination with the initial division of the bulk of articles into parallel streams of articles, so that there is formed one stream on the feeding conveyor for each robot to handle at the delivery end.

In the following, the invention is described in more detail with reference to the accompanying drawings, in which:

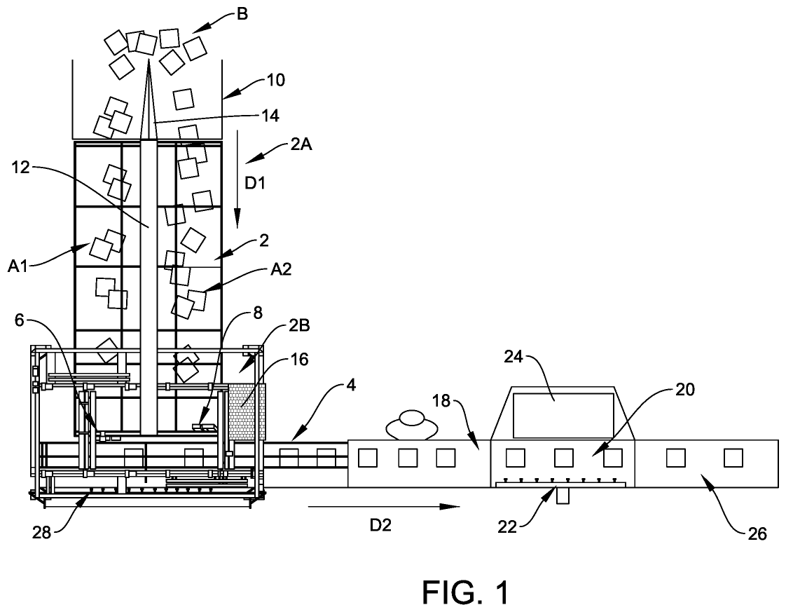

FIG. 1 is a schematic view of a system for separating and singulating articles according to the invention; and

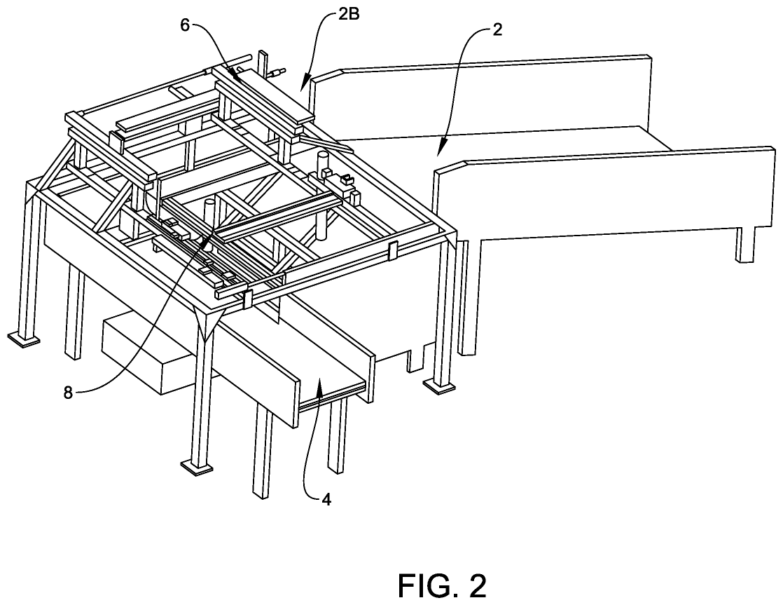

FIG. 2 is a perspective detailed view of the robotic singulation of this system.

In FIG. 1 there is shown a system for separating and singulating postal parcels or small packages according to an embodiment of the invention. A feeding conveyor 2 having a receiving end 2A and a delivery end 2B receives a bulk of articles which are delivered onto the feeding conveyor 2 from a cascading chute 10. The chute 10 is provided with a divider 14 for separating the bulk of postal articles B arriving in the chute into two parallel article streams A1, A2 on the feeding conveyor 2 and forwarding said article streams A1, A2 with a virtual separation zone 12 in a first conveying direction D1 from the receiving end 2A to the delivery end 2B.

The feeding conveyor 2 abuts at its delivery end 2B the upstream end of a takeaway conveyor 4 which has a second conveying direction D2, which is substantially different from said first conveying direction D1, preferably the two directions are perpendicular as shown in the figure.

Across the delivery end 2B of the feeding conveyor 2, there are provided a gantry robot 6, 8 for each article stream A1, A2. Each robot 6, 8 is handling each their article stream A1, A2 on the feeding conveyor 2. The gantry robots 6, 8 are 3-axis Cartesian robots and/or 6-axis Cartesian robots.

The gantry robots 6, 8 are adapted to pneumatically picking an article from each their article stream on the feeding conveyor 2 and placing the picked article on the takeaway conveyor 4. The robots are provided with a pneumatic pick-up head, which comprises a suction cup which is operated by vacuum for picking an article on the feeding conveyor 2. Beside each of the gantry robots 6, 8 there are arranged a tool exchange magazine 16 (only shown for one of the robots in FIG. 1). The tool exchange magazines 16 are provided on each side of the delivery end 2B of the feeding conveyor 2. In the tool exchange magazine 16, the robot can automatically disconnect the pick-up tool if there is detected a damage of the suction cup and connect a new pick-up head to the robot.

The system also comprises a vision system (not shown) adapted to capturing image data of the articles on the feeding conveyor 2. These image data are processed in a robotic controller comprising a data processing unit to identify an article to be singulated by one of the robots. The vision system is preferably adapted to record image data of the articles on both of the article streams on the feeding conveyor.

The articles have been picked up from the article streams A1, A2 on the feeding conveyor 2 and placed on the takeaway conveyor 4 in a singulated manner. Means for providing a placing confirmation 28 may be provided, such as a vision system to provide feedback to the robotic controller (not shown). Downstream where the feeding conveyor 2 abuts the takeaway conveyor 4, the takeaway conveyor 4 is provided with an operator station 18 and an auto reject station 20. The auto reject station 20 comprises an air guided reject actuator 22 on one side of the takeaway conveyor 4 and a collection bin 24 on the opposite side thereof.

As shown in FIG. 2, the feeding conveyor 2 has its delivery end 2B in the same level as the takeaway conveyor 4. This means that if any articles cannot be handled by the two gantry robots 6, 8, such unhandled articles will be delivered onto the takeaway conveyor 4. From here, such articles can be manually handled in the operator station 18 and/or rejected in the auto reject station 20. As an example, such articles can be odd-shaped articles or a cluster of articles with a too complex geometry for the robots to be able to handle them.

The invention is described above and illustrated in the drawings with reference to a gantry robot. By the term “a gantry robot” is meant a robot that comprises a manipulator mounted onto an overhead system that allows movement across a horizontal plane. Gantry robots may also be called Cartesian or linear robots and are found advantageous in large systems that perform pick and place applications.

By the invention, it is found advantageous that gantry robot systems provide the advantage of large work areas and good positioning accuracy. Position accuracy is the ability of the robot to place a part correctly. Furthermore, gantry robots are easy to program, with respect to motion, because they work with an X, Y, Z coordinate system. Another advantage is that the gantry robots are less limited by floor space constraints.

However, by the invention, it is realized that the robot types that could be used for the present singulator solution could also be a 6-axis robot type, a SCARA robot type (SCARA: Selective Compliance Assembly Robot Arm or Selective Compliance Articulated Robot Arm) or a Delta robot.

A SCARA robot may comprise an arm which is rigid in the Z-axis and pliable in the XY-axes, which allowed it to adapt to holes in the XY-axes. The SCARA is the jointed two-link arm layout similar to our human arms. This feature allows the arm to extend into confined areas and then retract or “fold up” out of the way. This is advantageous for transferring parts from one place to another.

The delta robot is a parallel robot, which comprises multiple kinematic chains connecting a base with the end-effector. The robot can also be seen as a spatial generalisation of a four-bar linkage.

The key concept of the delta robot is the use of parallelograms which restrict the movement of the end platform to pure translation, i.e. only movement in the X, Y or Z direction with no rotation.

The robot's base is mounted above the workspace and all its actuators are located on it. From the base, three middle jointed arms extend. The ends of these arms are connected to a small triangular platform. Actuation of the input links will move the triangular platform along the X, Y or Z direction. Actuation can be done with linear or rotational actuators, with or without reductions (direct drive). Since the actuators are all located in the base, the arms can be made of a light composite material. Because of this, the moving parts of the delta robot have a small inertia. This allows for very high speed and high accelerations. Having all the arms connected together to the end-effector increases the robot stiffness, but reduces its working volume.

Above the invention has been described with reference to some currently preferred specified embodiments. However, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. Furthermore, individual features mentioned in different claims, may possibly be advantageously combined, and the mentioning of these features in different claims does not exclude that a combination of features is not possible and advantageous.

1. A system for separating and singulating articles, such as postal parcels or small packages, said system comprising
a feeding conveyor having a receiving end and a delivery end separating the bulk of postal articles arriving on the feeding conveyor into a plurality of parallel article streams on the feeding conveyor and forwarding said article streams in a first conveying direction from said receiving end to said delivery end;
a takeaway conveyor having a second conveying direction, which is substantially different from said first conveying direction, and where said takeaway conveyor at its upstream end is abutted by the delivery end of said feeding conveyor;
a plurality of robots provided in parallel across the delivery end of the feeding conveyor in such a way that each robot is handling each their article stream on the feeding conveyor and that the robots are adapted to picking an article from each their article stream on the feeding conveyor and placing said picked article on the takeaway conveyor;
a vision system adapted to capturing image data of the articles on the feeding conveyor, and
a robotic controller comprising a data processing unit for using said image data to identify an article to be singulated by one of the robots and for providing control inputs to the robots.

2. A system according to claim 1, wherein the feeding conveyor comprises a divider for separating the bulk of postal articles arriving on the feeding conveyor.

3. A system according to claim 2, wherein the divider comprises a cascading diverter chute is provided upstream the feeding conveyor and preferably with a divider element for the formation of two parallel article streams, preferably a centrally positioned divider element.

4. A system according to claim 1, wherein the second conveying direction is substantially perpendicular to said first conveying direction.

5. A system according to claim 1, wherein the conveying velocity of the feeding conveyor and/or the takeaway conveyor is variable.

6. A system according to claim 1, wherein the feeding conveyor is intermittently driven (start-stop).

7. A system according to claim 1, wherein the robots are placing the picked article on the takeaway conveyor in a placement area at the upstream end of said takeaway conveyor.

8. A system according to claim 1, wherein the robots are gantry robots.

9. A system according to claim 8, wherein the gantry robots are 3-axis Cartesian robots and/or 6-axis Cartesian robots.

10. A system according to claim 1, wherein the robots may be any one of SCARA robot, a delta robot or 6-axis robot type.

11. A system according to claim 1, wherein the robots are each provided with a gripper for picking an article from each their article stream.

12. A system according to claim 11, wherein the robot grippers are adapted to pneumatically picking an article from each their article stream.

13. A system according to claim 11, wherein the robot grippers comprise pneumatic suction cups, mechanical gripping fingers, or hybrid design grippers that utilize a suction cup primarily assisted with a mechanical finger gripper.

14. A system according to claim 11, wherein soft robot gripper that has a controlled movement by adjusting pressure through combinations of pneumatic networks.

15. A system according to claim 1, wherein the vision system is adapted to record image data of the articles on all of the article streams on the feeding conveyor.

16. A system according to claim 1, wherein the takeaway conveyor after the delivery end of feeding conveyor is provided with an operator station and an auto reject station.

17. A system according to claim 16, wherein the auto reject station comprises an air guided reject actuator on one side of the takeaway conveyor and a collection bin on the opposite side thereof.

18. A system according to claim 1, wherein a tool exchange magazine for each of the gantry robots is provided on the side of the delivery end of the feeding conveyor.

19. A system according to claim 1, wherein the gantry robots are provided with overlap and the data processing unit is adapted for ensuring a sequential placing of articles by the robots.

20. A method of separating and singulating articles, such as postal parcels or small packages, comprising the steps of:
providing a bulk of postal articles, and
dividing said bulk of articles into a plurality of parallel article streams on a feeding conveyor and forwarding said article streams in a first conveying direction from a receiving end to a delivery end of said feeding conveyor;
providing a takeaway conveyor having a second conveying direction, which is substantially different from said first conveying direction, and where said takeaway conveyor at its upstream end is abutted by the delivery end of said feeding conveyor;
providing a plurality of robots in parallel across the delivery end of the feeding conveyor in such a way that each robot is handling each their article stream on the feeding conveyor and that the robots are adapted to picking an article from each their article stream on the feeding conveyor and placing said picked article on the takeaway conveyor;
capturing image data of the articles in the article streams on the feeding conveyor by a vision system adapted to, and processing said image data in a data processing unit of a robotic controller to identify an article to be singulated and moved onto the takeaway conveyor by one of the gantry robots and for providing control inputs to the robots.

21. A method according to claim 20, whereby the step of dividing the bulk of articles in a cascading diverter chute is provided upstream the feeding conveyor for the formation of two parallel article streams, preferably by a centrally positioned divider.

22. A method according to claim 20, whereby the robots are placing the picked article on the takeaway conveyor in a placement area at the upstream end of said takeaway conveyor.

23. A method according to any of claims 20, whereby the conveying velocity of the feeding conveyor and/or the takeaway conveyor is variable and either continuously or driven (start-stop).

24. A method according to any of claims 20, wherein the robots are each provided with a gripper for picking an article from each their article stream and wherein the robot grippers are adapted to pneumatically picking an article from each their article stream.

25. A method according to any of claims 20, whereby the vision system is adapted to record image data of the articles on all of the article streams on the feeding conveyor.

26. A method according to any of claims 20, whereby the takeaway conveyor after the delivery end of feeding conveyor is provided with an operator station and an auto reject station.

27. A method according to any of claims 20, whereby the auto reject station comprises an air guided reject actuator on one side of the takeaway conveyor and a collection bin on the opposite side thereof.

28. A method according to any of claims 20, whereby the second conveying direction is substantially perpendicular to said first conveying direction.

29. A method according to any of claims 20, whereby the gantry robots are provided with overlap and the robotic controller and the data processing unit is adapted for ensuring a sequential placing of articles by the robots.
